(19) United States
(12) Patent Application Publication
(10) Pub. No.: US 2006/0215095 A1
(43) Pub. Date: Sep. 28, 2006

(54) Laser-writing alignment marks on alignment layer to align liquid crystals

(76) Inventors: Qin Liu, Corvallis, OR (US); Curt Lee Nelson, Corvallis, OR (US); Gregg Combs, Monmouth, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/089,974

(22) Filed: Mar. 26, 2005

(51) Int. Cl. G02F 1/1337

(52) U.S. Cl. 349/124

(57) ABSTRACT

An alignment layer is provided over liquid crystals for a display. Alignment marks are laser-written on the alignment layer, such that the liquid crystals become aligned with one another.

### BACKGROUND

Flat-panel displays have become increasingly popular for computer and non-computer applications. One type of flat-panel display is the liquid crystal display (LCD), which is found in nearly all notebook and laptop computers, and is popular as well in stand-alone monitors for desktop computers and home theater displays and televisions. The liquid crystals of an LCD have voltages applied thereto to cause them to display images in accordance with image data received from a computer or other device.

During the manufacture of LCD's, the liquid crystals of an LCD have to be aligned with one another. The most popular alignment technique is currently to mechanically or physically rub an alignment layer positioned over the liquid crystals. However, rubbing can generate undesired particles, as well as create static electricity, potentially damaging the LCD's. Other techniques involve optical alignment in such varied ways as photoisomerization, photocrosslinking, and photodegradation, among others. However, the resulting alignment can be insufficiently stable, especially when the LCD is later subjected to ultraviolet light or heightened temperatures.

### BRIEF DESCRIPTION OF THE DRAWINGS

The drawings referenced herein form a part of the specification. Features shown in the drawing are meant as illustrative of only some embodiments of the invention, and not of all embodiments of the invention.

FIG. 1 is a diagram depicting homogenous alignment of liquid crystals of a display, according to an embodiment of the invention.

FIGS. 2A and 2B are diagrams of laser-written homogenous alignment marks on an alignment layer of a display, according to an embodiment of the invention.

FIG. 3 is a diagram depicting homotropic alignment of liquid crystals of a display, according to an embodiment of the invention.

FIGS. 4A and 4B are diagrams of a laser-written homotropic alignment mark on an alignment layer of a display, according to an embodiment of the invention.

FIG. 5 is a diagram depicting generally how a laser can be employed to create laser-written alignment marks on an alignment layer of a display, according to an embodiment of the invention.

FIG. 6 is a diagram depicting how a mask can be used in conjunction with a laser to create laser-written alignment marks, according to an embodiment of the invention.

FIG. 7 is a diagram depicting how multiple lasers can be used to create laser-written alignment marks, according to an embodiment of the invention.

FIG. 8 is a diagram depicting how a laser beam can be split and focused to create laser-written alignment marks, according to an embodiment of the invention.

FIG. 9 is a diagram depicting liquid crystals organized into different multiple-domain structures, where the liquid crystals of each structure can be differently aligned, according to an embodiment of the invention.

FIG. 10 is a flowchart of a method for laser-writing alignment marks on an alignment layer of a display to align the liquid crystals of the display, according to an embodiment of the invention.

### DETAILED DESCRIPTION OF THE DRAWINGS

In the following detailed description of exemplary embodiments of the invention, reference is made to the accompanying drawings that form a part thereof, and in which is shown by way of illustration specific exemplary embodiments in which the invention may be practiced. These embodiments are described in sufficient detail to enable those skilled in the art to practice the invention. Other embodiments may be utilized, and logical, mechanical, electrical, electro-optical, software/firmware and other changes may be made without departing from the spirit or scope of the present invention. The following detailed description is, therefore, not to be taken in a limiting sense, and the scope of the present invention is defined only by the appended claims.

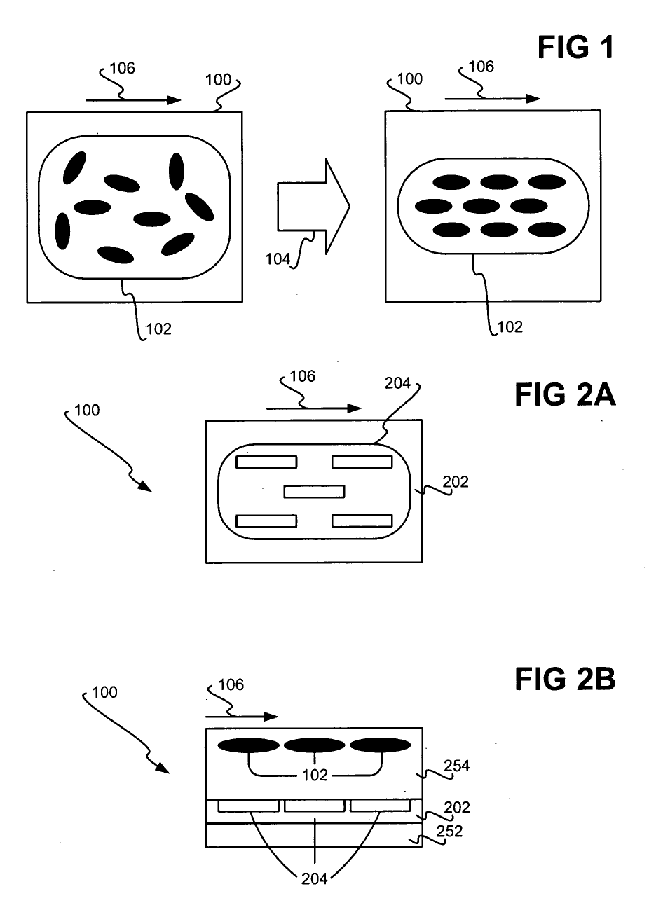

FIG. 1 shows how the liquid crystals 102 of a display 100 become homogenously aligned, according to an embodiment of the invention. FIG. 1 specifically shows a top view of the display 100. To the left of the arrow 104, the liquid crystals 102 of the display 100 are unaligned. Homogenous alignment refers to alignment of the liquid crystals 102 in a direction substantially parallel to the surface of the display 100, as indicated by the arrow 106. The liquid crystals 102 are substantially parallel to the surface of the display 100, as opposed to being exactly parallel to the surface of the display 100, because they may be oriented such that they have a small pre-tilt angle, of less than five degrees in one embodiment, from being completely parallel. Thus, the unaligned liquid crystals 102 to the left of the arrow 104 are oriented, or point, in all different directions. Homogenous alignment is represented by the arrow 104. To the right of the arrow 104 then, the liquid crystals 102 of the display 100 are homogenously aligned. That is, the aligned liquid crystals 102 to the right of the arrow 104 are oriented, or point, in substantially the same direction, parallel to the arrow 104. The liquid crystals 102 themselves may be twisted nematic (TN) crystals, as well as other types of liquid crystals.

The display 100 is generally a display that employs liquid crystals. Such displays include displays that are either flexible or rigid. Such displays can include what are commonly known as liquid-crystal displays (LCD's), which are usually found in laptop, notebook, and other types of portable computers and other portable devices, as well as those which are available as stand-alone monitors. However, the display 100 can be any type of other display that uses, contains, or has liquid crystals.

FIGS. 2A and 2B show examples of laser-written homogenous alignment marks 204 on an alignment layer 202 of the display 100, according to an embodiment of the invention. FIG. 2A specifically depicts a top view, whereas FIG. 2B specifically depicts a cross-sectional side view. The alignment marks 204 are elongated rectangular-shaped slots, or trenches, in one embodiment, which are written within the alignment layer 202 by a laser. The alignment marks 204 are homogenous alignment marks in that they are at least substantially parallel to a surface of the display 100, as indicated by the arrow 106, and result in the liquid crystals 102 to become homogenously aligned. Whereas the alignment marks 204 are depicted in FIG. 2A as being discrete marks, in another embodiment they can be continuous marks, or lines, extending across the entire surface of the alignment layer 202.

FIG. 2B shows how the liquid crystals 102 within a liquid crystal layer 254 of the display 100 become aligned to the alignment marks 204 within the alignment layer 202 of the display 100, and thus how the liquid crystals 102 become aligned with one another. In particular, the liquid crystals 102 orientate themselves alongside and substantially parallel with the alignment marks 204 laser-written into the alignment layer 202. In this way, the liquid crystals 102 become aligned. The alignment marks 204 are typically much larger than the liquid crystals 102 themselves, such that even though just one liquid crystal is shown being aligned to each alignment mark in FIG. 2B, this is for illustrative convenience, and in general a number of liquid crystals will align to each mark.

FIG. 2B further depicts the basic structure of the display 100 on a layer-by-layer basis. On top of a substrate 252 is the alignment layer 202, and on top of the alignment layer 202 is the liquid crystal layer 254 within which the liquid crystals 102 are disposed. The alignment layer 202 may be a polyimide or other type of polymer films, inorganic films like silicon oxide (SiOₓ), as well as organic films, and mixtures thereof. The height of the alignment layer 202 may be 15-100 nanometers (nm) in one embodiment of the invention. As can be appreciated by those of ordinary skill within the art, the display 100 can and typically will have additional layers, besides the substrate 252 and the layers 254 and 202 shown in FIG. 2B.

The homogenous alignment marks 204 that are laser-written into the alignment layer 202 in FIGS. 2A and 2B are in one embodiment comparable to alignment marks that are created within alignment layers by mechanical or physical rubbing. However, laser-written alignment marks 204 are advantageous for at least two reasons. First, because the laser-writing process is inherently more controllable than the manner by which alignment marks are engrained via rubbing, the location and size of the alignment marks 204 can be precisely specified. Second, because the laser-writing process does not involve actual physical contact with the alignment layer 202, particle generation and static electricity typically are not issues as they are with mechanical or physical rubbing.

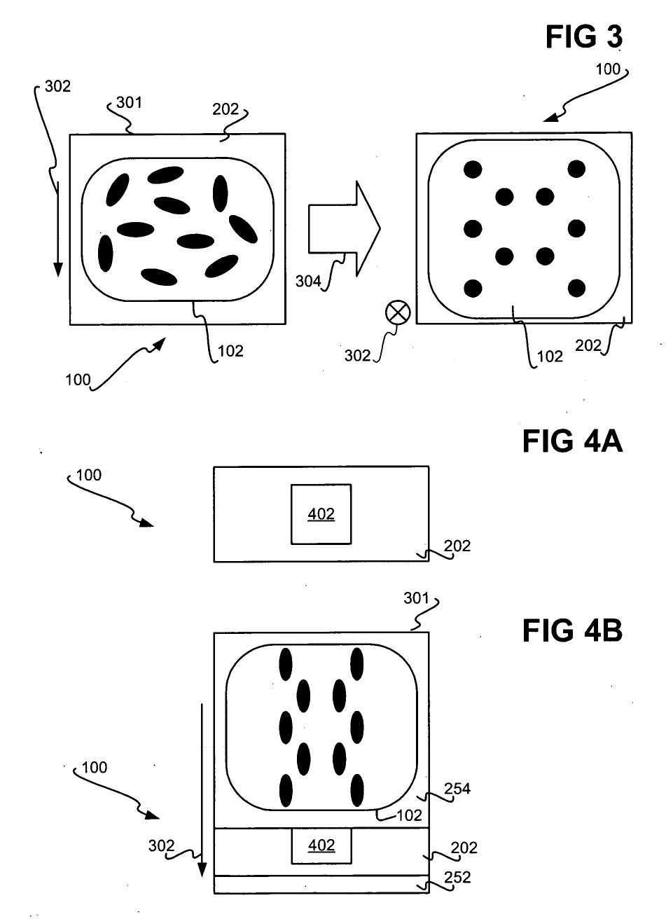

FIG. 3 shows how the liquid crystals 102 of the display 100 become homotropically aligned, according to an embodiment of the invention. FIG. 3A specifically shows a cross-sectional side view of the display 100, whereas FIG. 3B shows a top view of the display 100. To the left of the arrow 304, the liquid crystals 102 of the display 100 are unaligned. Homotropic alignment refers to alignment of the liquid crystals 102 in a direction substantially perpendicular to a surface 301 of the alignment layer 202, as indicated by the arrow 302. Thus, the unaligned crystals 102 to the left of the arrow 304 are oriented, or point, in all different directions.

Homotropic alignment is represented by the arrow 304. To the right of the arrow 304 then, the liquid crystals 102 of the display 100 are homotropically aligned. That is, the aligned liquid crystals 102 to the right of the arrow 304 are all oriented in substantially the same direction, along the arrow 302, which in FIG. 3B is directed downwards because FIG. 3B is a top view. The difference between homogenous and homotropic alignment has to do with the direction of alignment. Homogenous alignment relates to a direction substantially parallel to the surface of the alignment layer 202, whereas homotropic alignment relates to a direction substantially perpendicular to the surface of the alignment layer 202.

FIGS. 4A and 4B show an example of a laser-written homotropic alignment mark 402 on the alignment layer 202 of the display 100, according to an embodiment of the invention. FIG. 4A specifically depicts a top view of the alignment layer 202, whereas FIG. 4B specifically depicts a cross-sectional side view of the display 100. The alignment mark 402 is a square-shaped pillar, hole, or via, in one embodiment, which is written within the alignment layer 202 by a laser. The alignment mark 402 is a homotropic alignment mark in that it is substantially perpendicular to the top surface 301 of the alignment layer 202, as indicated by the arrow 302, and results in the liquid crystals 102 to become homotropically aligned. The alignment mark 402 may extend substantially the depth of the alignment layer 202. The homotropic alignment mark 402 is different in shape than the homogenous alignment marks 204 of FIGS. 2A and 2B. Furthermore, the homotropic alignment mark 402 is different than the homogenous alignment marks 204 of FIGS. 2A and 2B in that the alignment mark 402 may be deeper within the alignment layer 202 than are the homogenous alignment marks 204. The alignment marks 204 and 402 are generally nano-scale structures of various shapes and dimensions.

FIG. 4B shows how the liquid crystals 102 within the liquid crystal layer 254 of the display 100 become aligned to the alignment mark 402 within the alignment layer 202 of the display 100, and thus how the liquid crystals 102 become aligned with one another. In particular, the liquid crystals 102 align themselves end-to-end over the alignment mark 402 laser-written into the alignment layer 202, in the direction indicated by the arrow 302. In this way, the liquid crystals 102 become aligned.

The homotropic alignment mark 402 that is laser-written into the alignment layer 202 in FIGS. 4A and 4B could not typically be created using mechanical or physical rubbing. That is, rubbing generally only allows for the generation of the homogenous alignment marks, not homotropic alignment marks. Furthermore, although both the homotropic alignment mark 402 of FIGS. 4A and 4B and the homogenous alignment marks 204 of FIGS. 2A and 2B are created using light, in that a laser is used to write or generate the alignment marks 402 and 204, this alignment process is different than the optical alignment processes of the prior art. In particular, the optical alignment processes of the prior art leverage various reactions of the liquid crystals and/or the alignment layer itself to light, such as photoisomerization, photocrosslinking, and photodegradation. By comparison, the alignment process of FIGS. 2B and 4B, for instance, does not rely on such reaction of the liquid crystals or the alignment layer to light, but rather employs physical alignment marks that have been laser-written into the alignment layer.

It is noted that the actual mechanism by which liquid crystals become aligned with one another is not necessarily known. It can be said that the liquid crystals become aligned after the alignment marks have been laser-written onto the alignment layer, but the exact manner as to which they become aligned is not necessarily known.

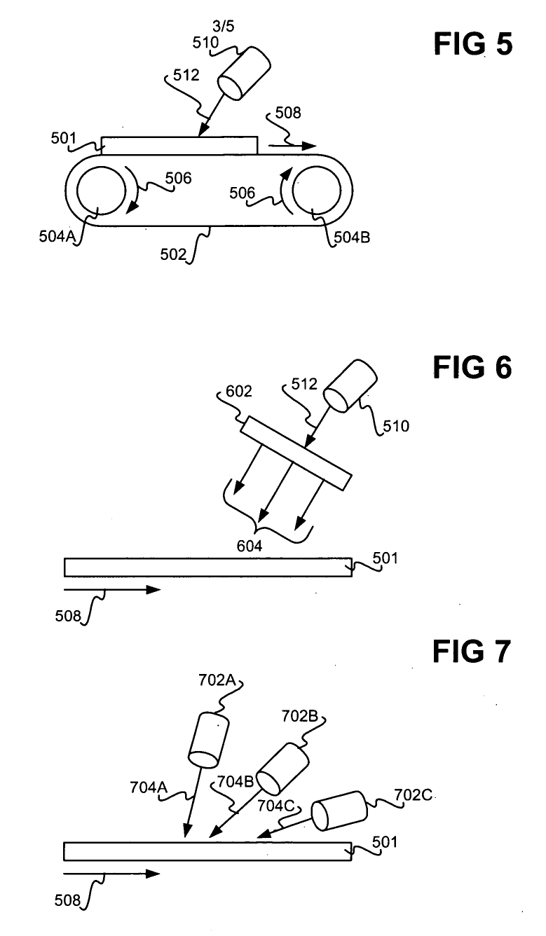

FIG. 5 shows generally how a laser can be used to generate the laser-written alignment marks that have been described, according to an embodiment of the invention. FIG. 5 specifically shows a side view of this process. In FIG. 5, a display substrate 501 moves from left to right, as indicated by the arrow 508, on a conveyor belt 502. The display substrate 501 can in one embodiment include the substrate 252 and the alignment layer 254 of the display 100 of FIGS. 2B and 4B that have been described. Rollers 504A and 504B, collectively referred to as the rollers 504, rotate in the direction indicated by the arrows 506 to cause movement of the conveyor belt 502. As can be appreciated by those of ordinary skill within the art, different movement mechanisms, other than a conveyor belt and rollers, may be employed to move the display substrate 501 from left to right.

The approach depicted in FIG. 5 can be used for both flexible and rigid display substrates. Rigid substrates include glass, whereas flexible substrates include plastic or metal films. The display substrate, in the embodiment where it is a flexible substrate, may be treated as a continuous roll of the substrate is unwound from a supply roll and wound onto a take-up roll.

As the display substrate 501 moves from left to right, a laser beam source 510 generates a laser beam 512. The laser beam 512 generates the laser-written alignment marks that have been described. In one embodiment, by appropriately turning on and off and controlling the power of the laser beam 512 as the display substrate 501 moves from left to right, and by appropriately scanning the laser beam 512 in a direction substantially perpendicular to the plane of FIG. 5, different types of alignment marks can be laser written. For instance, either or both the homogenous alignment marks 204 of FIGS. 2A and 2B and the homotropic alignment marks 402 of FIGS. 4A and 4B can be created.

In an alternative embodiment, one or more galvanometer mirrors may be employed, such that the display substrate 501 remains stationary, while the laser beam 512 emitted from the laser beam source 510 is moved over different portions of the display substrate 501 via rotation of the mirrors, as can be appreciated by those of ordinary skill within the art. Furthermore, a mask may also be employed in conjunction with the embodiment of FIG. 5, as is now specifically described in relation to FIG. 6.

FIG. 6 shows more specifically how a mask 602 can be used in conjunction with the laser beam 512 to generate the laser-written alignment marks that have been described, according to an embodiment of the invention. FIG. 6 specifically shows a side view of this process. The display substrate 501 again moves from left to right, as indicated by the arrow 508, but the manner by which such movement is caused is not depicted specifically in FIG. 6. The laser beam 512 generated by the laser beam source 510 and passes through a mask 602, resulting in a patterned laser beam 604, which then specifically is incident to the display substrate 501. Different types of laser masks can be used to result in different types of laser beam patterns, and thus to laser-write different types of alignment marks. For example, where the laser beam 512 has a power of thirty milli-joules per square centimeter (mJ/cm²), the resulting homogenous alignment marks have depths of greater than fifty angstroms.

FIG. 7 shows more specifically how multiple laser beam sources 702A, 702B, and 702C can be used to generate the laser-written alignment marks that have been described, according to an embodiment of the invention. FIG. 7 specifically shows a side view of this process. The laser beam sources 702A, 702B, and 702C are collectively referred to as the laser beam sources 702, and generate laser beams 704A, 704B, and 704C, collectively referred to as the laser beams 704. The display substrate 501 again moves from left to right, as indicated by the arrow 508, but the manner by which such movement is caused is not depicted specifically in FIG. 7. The mask 602 may further be used in the embodiment of FIG. 7, but is not shown in FIG. 7.

The laser beam sources 702 as shown in FIG. 7 are organized so that their laser beams 704 impinge the display substrate 501 at different angles of incidence. The laser beam sources 702 may be scanned into and out of the plane of FIG. 7 in one embodiment. Furthermore, in another embodiment, the laser beam sources 702 may be organized substantially perpendicular to the plane of FIG. 7, and oriented to result in the same or different angles of incidence of their laser beams 704 relative to the display substrate 501, so that scanning is not needed. The configuration, number, and orientation of the laser beam sources 702 can be varied to result in different types of laser-written alignment marks being created. Furthermore, with multiple laser beams, process rate can be increased, and/or multiple-domain structures, as will be described in relation to FIG. 9, can be provided. In addition, changing the angle of incidence of the laser beams 704 with respect to the display substrate 501 may change the pre-tilt angles of the liquid crystals as aligned.

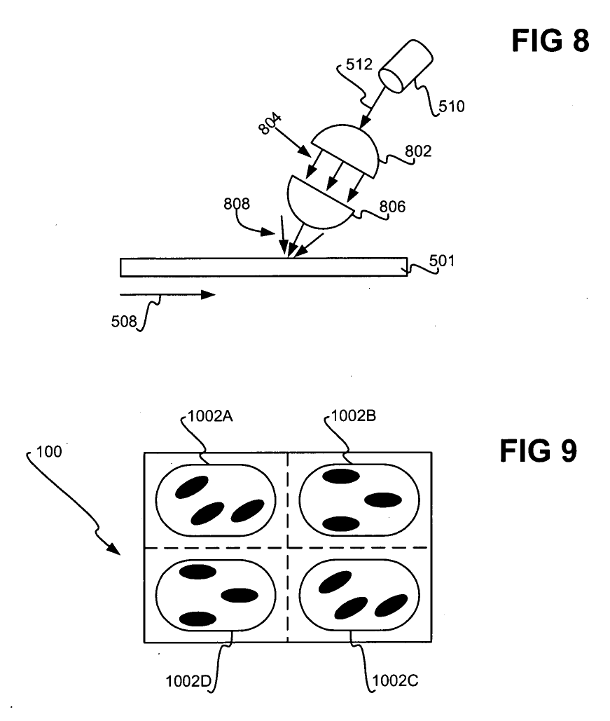

FIG. 8 shows more specifically how the laser beam 512 can be split into multiple beams, which are then focused to generate the laser-written alignment marks that have been described, according to an embodiment of the invention. FIG. 8 specifically shows a side view of this process. The display substrate 501 again moves from left to right, as indicated by the arrow 508, but the manner by which such movement is caused is not depicted specifically in FIG. 8. The laser beam 512 is split into a number of laser beams 804 via a beam splitter 802, and then individual beams are focused onto a common area via the lens 806. The single laser beam 808 specifically impinges the display substrate 501.

The splitting and focusing of the laser beam 512 can in one embodiment cause a particular type of optical interference pattern, depending on the characteristics of the beam splitter 802 and/or the lens 806. Thus, by controlling these characteristics, the optical interference pattern can be controlled. Controlling the optical interference pattern in turn can result in different types of laser-written alignment marks being created. The mask 602 may further be used in the embodiment of FIG. 8, but is not shown in FIG. 8.

FIG. 9 shows how the liquid crystals of the display substrate 501 may be organized into different liquid crystal multiple-domain structures 1002A, 1002B, 1002C, and 1002D, according to an embodiment of the invention. FIG. 9 specifically shows a top view of the display substrate 501. The multiple-domain structures 1002A, 1002B, 1002C, and 1002D are collectively referred to as the multiple-domain structures 1002. Because the laser-written alignment marks that have been described can be precisely generated, the liquid crystals of different multiple-domain structures can be differently aligned, which is generally not possible by alignment marks generated by physical or mechanical rubbing in the prior art. That is, different sets of alignment marks can be generated for different multiple-domain structures. Thus, as one example, the liquid crystals of the multiple-domain structures 1002A and 1002C are aligned in one way, whereas the liquid crystals of the multiple-domain structures 1002B and 1002D are aligned in a different way.

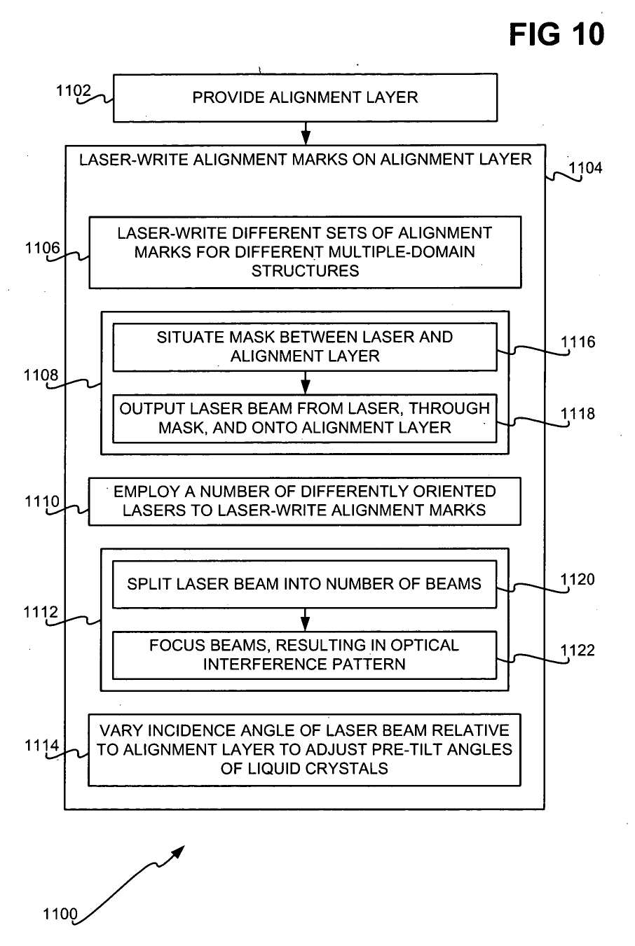

FIG. 10 shows a method 1100 for generating the laser-written alignment marks that have been described to result in the liquid crystals of a display to become aligned with one another, according to an embodiment of the invention. The method 1100 can thus be employed to at least partially fabricate a display. Specifically, the method 1100 can be employed to align the liquid crystals of a display.

An alignment layer is provided (1102), such as over a substrate, where a layer of liquid crystals may then ultimately be provided over the alignment layer. Alignment marks are laser-written on the alignment layer to align the liquid crystals (1104). The laser-written alignment marks may include the homogenous alignment marks of FIGS. 2A and 2B, as well as the homotropic alignment marks of FIGS. 4A and 4B.

In various embodiments of the invention, laser-writing the alignment marks on the alignment layer may include performing 1106, 1108, 1110, 1112, and/or 1114. Thus, different sets of alignment marks may be laser-written for different multiple-domain structures into which the liquid crystals have been organized (1106), as has been described in relation to FIG. 9. In 1108, a mask may be situated between the laser beam source and the alignment layer (1116), such that the laser beam is output from the laser beam source, through the mask, and onto the alignment layer (1118), as has been described in relation to FIG. 6. A mask may alternatively be used in conjunction with 1106, too.

A number of differently oriented laser beam sources may also be employed to laser-write the alignment marks (1110), as has been described in relation to FIG. 7. In 1112, the laser beam may be split into a number of different laser beams (1120), which are then focused to result in a particular optical interference pattern (1122), as has been described in relation to FIG. 8. A mask may alternatively be used in conjunction with 1110 and 1112, too. Furthermore, the incidence angle of the laser beam relative to the alignment layer may be varied to adjust the pre-tilt angles of the liquid crystals (1114).

It is noted that, although specific embodiments have been illustrated and described herein, it will be appreciated by those of ordinary skill in the art that any arrangement is calculated to achieve the same purpose may be substituted for the specific embodiments shown. This application is intended to cover any adaptations or variations of the present invention. Therefore, it is manifestly intended that this invention be limited only by the claims and equivalents thereof.

We claim:

1. A method comprising:
providing an alignment layer over a plurality of liquid crystals for a display; and,
laser-writing a plurality of alignment marks on the alignment layer, such that the liquid crystals become aligned with one another.

2. The method of claim 1, wherein laser-writing the alignment marks on the alignment layer comprises laser-writing a plurality of homogenous alignment marks at least substantially parallel to a surface of the alignment layer.

3. The method of claim 1, wherein laser-writing the alignment marks on the alignment layer comprises laser-writing a plurality of homotropic alignment marks at least substantially perpendicular to a surface of the alignment layer.

4. The method of claim 1, wherein the liquid crystals are organized into a plurality of multiple-domain structures, and laser-writing the plurality of alignment marks on the alignment layer comprises laser-writing different sets of alignment marks for each of the multiple-domain structures of the liquid crystals.

5. The method of claim 1, wherein laser-writing the alignment marks on the alignment layer comprises:
situating a mask between a laser and the alignment layer; and,
outputting a laser beam from the laser, through the mask, and onto the alignment layer, such that the mask affects the laser beam to cause the alignment marks to be laser-written on the alignment layer.

6. The method of claim 1, wherein laser-writing the alignment marks on the alignment layer comprises employing a plurality of differently oriented lasers to laser-write the alignment marks on the alignment layer.

7. The method of claim 1, wherein laser-writing the alignment marks on the alignment layer comprises:
splitting a laser beam into a plurality of beams; and,
focusing the plurality of beams onto the alignment layer, resulting in an optical interference pattern.

8. The method of claim 1, wherein laser-writing the alignment marks on the alignment layer comprises varying an incidence angle of a laser relative to the alignment layer to adjust pre-tilt angles of the liquid crystals.

9. The method of claim 1, wherein laser-writing the plurality of alignment marks on the alignment layer is accomplished without contacting the alignment layer.

10. A display formed by performing a method comprising:
providing an alignment layer relative to which a plurality of liquid crystals for the display is to be disposed; and,
at least one of:
laser-writing a plurality of homogenous alignment marks at least substantially parallel to a surface of the alignment layer; and,
laser-writing a plurality of homotropic alignment marks at least substantially perpendicular to the surface of the alignment layer.

11. The display of claim 10, wherein the liquid crystals are organized into a plurality of multiple-domain structures, and different sets of the homogenous alignment marks and/or different sets of the homotropic alignment marks are laser-written for each of the multiple-domain structures of the liquid crystals.

12. The display of claim 10, wherein laser-writing each of the homogenous and homotropic alignment marks on the alignment layer comprises:
situating a mask between a laser and the alignment layer; and,
outputting a laser beam from the laser, through the mask, and onto the alignment layer, such that the mask affects the laser beam to cause the alignment marks to be laser-written on the alignment layer.

13. The display of claim 10, wherein laser-writing each of the homogenous and homotropic alignment marks on the alignment layer comprises employing a plurality of differently oriented lasers to laser-write the alignment marks on the alignment layer.

14. The display of claim 10, wherein laser-writing each of the homogenous and homotropic alignment marks on the alignment layer comprises:
splitting a laser beam into a plurality of beams; and,
focusing the plurality of beams onto the alignment layer, resulting in an optical interference pattern.

15. The display of claim 10, wherein laser-writing each of the homogenous and homotropic alignment marks on the alignment layer comprises varying an incidence angle of a laser relative to the alignment layer to adjust pre-tilt angles of the liquid crystals.

16. A display comprising:
a substrate;
an alignment layer over the substrate and having a plurality of laser-written alignment marks on a surface thereof; and,
a layer of liquid crystals situated over the alignment layer, the liquid crystals aligned to one another.

17. The display of claim 16, wherein the liquid crystals are homogenously aligned with one another, the laser-written alignment marks comprising homogenous alignment marks at least substantially parallel to the surface of the alignment layer.

18. The display of claim 16, wherein the liquid crystals are homotropically aligned with one another, the laser-written alignment marks comprising homotropic alignment marks at least substantially perpendicular to the surface of the alignment layer.

19. The display of claim 16, wherein the liquid crystals are organized into a plurality of multiple-domain structures, the plurality of alignment marks comprises different sets of alignment marks for each of the multiple-domain structures of the liquid crystals.

20. The display of claim 16, wherein the alignment layer comprises a polyimide film.

21. The display of claim 16, wherein the substrate is one of a flexible substrate and a rigid substrate.

22. A display comprising:
a plurality of liquid crystals; and,
laser-written means for aligning the plurality of liquid crystals with one another.

23. The display of claim 22, wherein the liquid crystals are homogenously aligned with one another, the laser-written means comprising a laser-written means for homogenously aligning the plurality of liquid crystals.

24. The display of claim 22, wherein the liquid crystals are homotropically aligned with one another, the laser-written means comprising a laser-written means for homotropically aligning the plurality of liquid crystals.
